(19) United States
(12) Patent Application Publication
(10) Pub. No.: US 2024/0361447 A1
(43) Pub. Date: Oct. 31, 2024

(54) INDOOR LOCALIZATION USING A STATE MACHINE

(71) Applicant: Samsung Electronics Co., Ltd., Suwon-si (KR)

(72) Inventors: Neha Dawar, McKinney, TX (US); Yuming Zhu, Plano, TX (US); Rebal Al Jurdi, Allen, TX (US); Boon Loong Ng, Plano, TX (US); Jianzhong Zhang, Dallas, TX (US); Qiang Xie, Suwon-si (KR); Sejong Yoon, Suwon-si (KR)

(21) Appl. No.: 18/626,235

(22) Filed: Apr. 3, 2024

Related U.S. Application Data
(60) Provisional application No. 63/460,239, filed on Apr. 18, 2023.

(51) Int. Cl. G01S 13/76; G01S 13/02; H04W 64/00

(52) U.S. Cl. CPC G01S 13/76; G01S 13/0209; H04W 64/00

(57) ABSTRACT

A method includes determining, for each time interval in a series of time intervals, (i) whether at least one wireless signal measurement was received in the time interval, each wireless signal measurement associated with a pair of anchors, and (ii) whether at least one step was detected in the time interval. The method also includes selecting a state of a tracking filter state machine based on whether the at least one wireless signal measurement was received in the time interval and whether the at least one step was detected in the time interval. The method further includes determining a location of an object using the tracking filter state machine based on the selected state.

### CROSS-REFERENCE TO RELATED APPLICATIONS(S) AND CLAIM OF PRIORITY

This application claims priority under 35 U.S.C. § 119(e) to U.S. Provisional Patent Application No. 63/460,239, filed on Apr. 18, 2023, which is hereby incorporated by reference in its entirety.

### TECHNICAL FIELD

This disclosure relates generally to wireless communications systems. Embodiments of this disclosure relate to methods and apparatuses for indoor localization of an object using a state machine.

### BACKGROUND

Indoor positioning has grown in popularity over the last decade with applications in both smart homes and commercial facilities. While most of the existing indoor positioning techniques (e.g., Bluetooth and Wi-Fi), suffer from poor accuracy, ultra-wide band (UWB) can provide a robust and accurate indoor localization solution. UWB-based localization techniques generally use two-way ranging (TWR) or time-of-arrival (ToA). However, these techniques cannot cater to multiple users at the same time, hence are not very scalable. On the other hand, in downlink time difference-of-arrival (DL-TDoA) the target does not directly communicate with the UWB anchors, but only listens to the downlink messages from the anchors. Hence, DL-TDoA not only serves multiple users at the same time, but also does not pose any privacy concerns.

### SUMMARY

Embodiments of the present disclosure provide methods and apparatuses for indoor localization of an object using a state machine.

In one embodiment, a method includes determining, for each time interval in a series of time intervals, (i) whether at least one wireless signal measurement was received in the time interval, each wireless signal measurement associated with a pair of anchors, and (ii) whether at least one step was detected in the time interval. The method also includes selecting a state of a tracking filter state machine based on whether the at least one wireless signal measurement was received in the time interval and whether the at least one step was detected in the time interval. The method further includes determining a location of an object using the tracking filter state machine based on the selected state.

In another embodiment, a device includes a transceiver and a processor operably connected to the transceiver. The processor is configured to: determine, for each time interval in a series of time intervals, (i) whether at least one wireless signal measurement was received in the time interval, each wireless signal measurement associated with a pair of anchors, and (ii) whether at least one step was detected in the time interval; select a state of a tracking filter state machine based on whether the at least one wireless signal measurement was received in the time interval and whether the at least one step was detected in the time interval; and determine a location of an object using the tracking filter state machine based on the selected state.

In another embodiment, a non-transitory computer readable medium includes program code that, when executed by a processor of a device, causes the device to: determine, for each time interval in a series of time intervals, (i) whether at least one wireless signal measurement was received in the time interval, each wireless signal measurement associated with a pair of anchors, and (ii) whether at least one step was detected in the time interval; select a state of a tracking filter state machine based on whether the at least one wireless signal measurement was received in the time interval and whether the at least one step was detected in the time interval; and determine a location of an object using the tracking filter state machine based on the selected state.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C. As used herein, such terms as “1st” and “2nd,” or “first” and “second” may be used to simply distinguish a corresponding component from another and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to various embodiments of the present disclosure;

FIG. 2A illustrates an example AP according to various embodiments of the present disclosure;

FIG. 2B illustrates an example STA according to various embodiments of the present disclosure;

FIG. 3 illustrates an example network in which DL-TDoA can be performed according to various embodiments of the present disclosure;

FIG. 4 illustrates an example system for performing indoor localization according to various embodiments of the present disclosure;

FIG. 5 illustrates an example error model for EKF-SH that can be used in the system of FIG. 4 according to various embodiments of the present disclosure;

FIG. 6 illustrates an example EKF−RW+SH state machine for use with the system of FIG. 4 according to various embodiments of the present disclosure;

FIG. 7 illustrates an example process for determining the state of the EKF−RW+SH state machine of FIG. 6 at the end of each ranging round, according to various embodiments of the present disclosure;

FIG. 8 illustrates an example timeline showing EKF−RW+SH state changes for an example set of UWB measurement receptions and step detections according to various embodiments of the present disclosure;

FIG. 9 illustrates an example timeline in which a fraction is calculated for one or more EKF−RW+SH steps when a step is detected, according to various embodiments of the present disclosure;

FIG. 10 illustrates an example timeline in which the last detected step length is extrapolated in the absence of UWB measurements and step detection, according to various embodiments of the present disclosure;

FIG. 11 illustrates an example process for determining the state of the EKF−RW+SH state machine where EKF−RW+SH is dominated by UWB measurements according to various embodiments of the present disclosure;

FIGS. 12 and 13 illustrate example processes for outlier removal and EKF−RW+SH according to various embodiments of the present disclosure; and

FIG. 14 illustrates a flow chart of a method for indoor localization of an object using a state machine according to various embodiments of the present disclosure.

### DETAILED DESCRIPTION

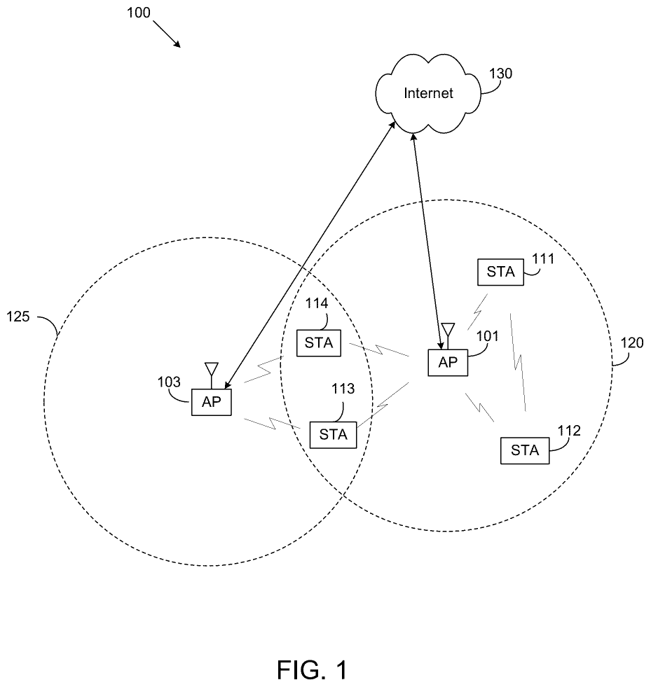

FIGS. 1 through 14, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Aspects, features, and advantages of the disclosure are readily apparent from the following detailed description, simply by illustrating a number of particular embodiments and implementations, including the best mode contemplated for carrying out the disclosure. The disclosure is also capable of other and different embodiments, and its several details can be modified in various obvious respects, all without departing from the spirit and scope of the disclosure. Accordingly, the drawings and description are to be regarded as illustrative in nature, and not as restrictive. The disclosure is illustrated by way of example, and not by way of limitation, in the figures of the accompanying drawings.

The present disclosure covers several components which can be used in conjunction or in combination with one another or can operate as standalone schemes. Certain embodiments of the disclosure may be derived by utilizing a combination of several of the embodiments listed below. Also, it should be noted that further embodiments may be derived by utilizing a particular subset of operational steps as disclosed in each of these embodiments. This disclosure should be understood to cover all such embodiments.

FIG. 1 illustrates an example wireless network 100 according to various embodiments of the present disclosure. The embodiment of the wireless network 100 shown in FIG. 1 is for illustration only. Other embodiments of the wireless network 100 could be used without departing from the scope of this disclosure.

The wireless network 100 includes access points (APs) 101 and 103. The APs 101 and 103 communicate with at least one network 130, such as the Internet, a proprietary Internet Protocol (IP) network, or other data network. The AP 101 provides wireless access to the network 130 for a plurality of stations (STAs) 111-114 within a coverage area 120 of the AP 101. The APs 101-103 may communicate with each other and with the STAs 111-114 using Wi-Fi or other WLAN (wireless local area network) communication techniques. The STAs 111-114 may communicate with each other using peer-to-peer protocols, such as Tunneled Direct Link Setup (TDLS).

Depending on the network type, other well-known terms may be used instead of “access point” or “AP,” such as “router” or “gateway.” For the sake of convenience, the term “AP” is used in this disclosure to refer to network infrastructure components that provide wireless access to remote terminals. In WLAN, given that the AP also contends for the wireless channel, the AP may also be referred to as a STA. Also, depending on the network type, other well-known terms may be used instead of “station” or “STA,” such as “mobile station,” “subscriber station,” “remote terminal,” “user equipment,” “wireless terminal,” or “user device.” For the sake of convenience, the terms “station” and “STA” are used in this disclosure to refer to remote wireless equipment that wirelessly accesses an AP or contends for a wireless channel in a WLAN, whether the STA is a mobile device (such as a mobile telephone or smartphone) or is normally considered a stationary device (such as a desktop computer, AP, media player, stationary sensor, television, etc.).

Dotted lines show the approximate extents of the coverage areas 120 and 125, which are shown as approximately circular for the purposes of illustration and explanation only. It should be clearly understood that the coverage areas associated with APs, such as the coverage areas 120 and 125, may have other shapes, including irregular shapes, depending upon the configuration of the APs and variations in the radio environment associated with natural and man-made obstructions.

As described in more detail below, one or more of the APs may include circuitry and/or programming to enable indoor localization of an object using a state machine. Although FIG. 1 illustrates one example of a wireless network 100, various changes may be made to FIG. 1. For example, the wireless network 100 could include any number of APs and any number of STAs in any suitable arrangement. Also, the AP 101 could communicate directly with any number of STAs and provide those STAs with wireless broadband access to the network 130. Similarly, each AP 101 and 103 could communicate directly with the network 130 and provide STAs with direct wireless broadband access to the network 130. Further, the APs 101 and/or 103 could provide access to other or additional external networks, such as external telephone networks or other types of data networks.

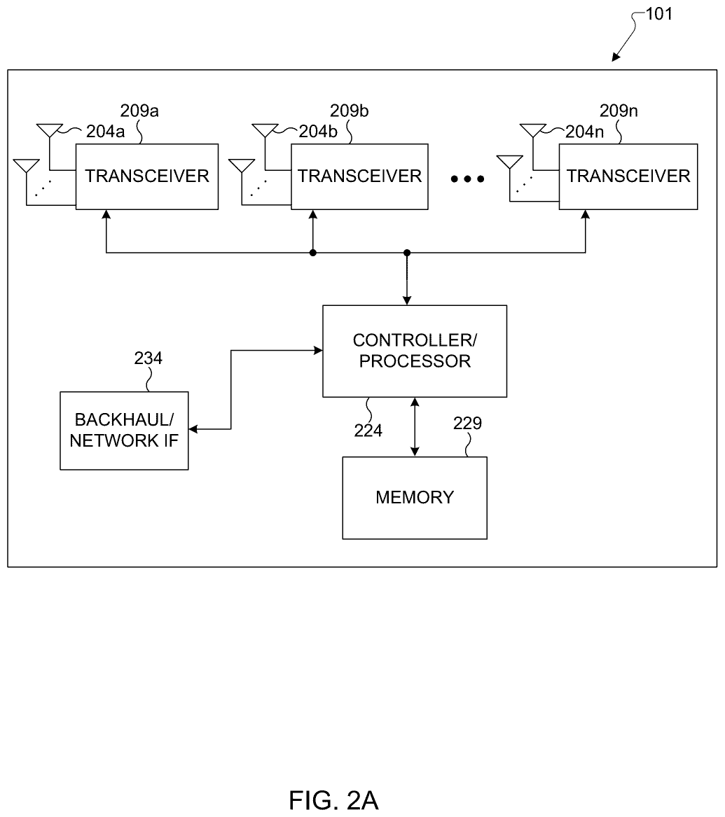

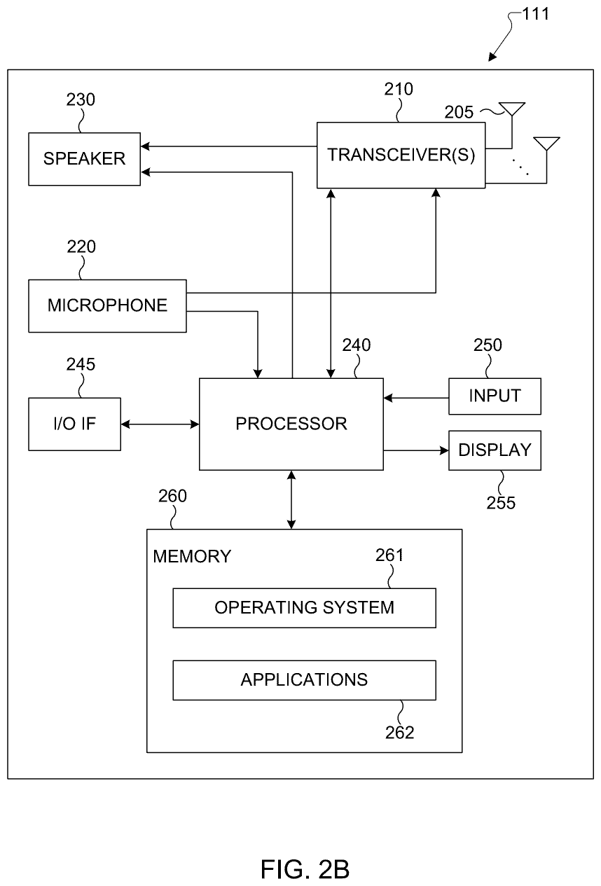

FIG. 2A illustrates an example AP 101 according to various embodiments of the present disclosure. The embodiment of the AP 101 illustrated in FIG. 2A is for illustration only, and the AP 103 of FIG. 1 could have the same or similar configuration. However, APs come in a wide variety of configurations, and FIG. 2A does not limit the scope of this disclosure to any particular implementation of an AP.

The AP 101 includes multiple antennas 204a-204n and multiple transceivers 209a-209n. The AP 101 also includes a controller/processor 224, a memory 229, and a backhaul or network interface 234. The transceivers 209a-209n receive, from the antennas 204a-204n, incoming radio frequency (RF) signals, such as signals transmitted by STAs 111-114 in the network 100. The transceivers 209a-209n down-convert the incoming RF signals to generate IF or baseband signals. The IF or baseband signals are processed by receive (RX) processing circuitry in the transceivers 209a-209n and/or controller/processor 224, which generates processed baseband signals by filtering, decoding, and/or digitizing the baseband or IF signals. The controller/processor 224 may further process the baseband signals.

Transmit (TX) processing circuitry in the transceivers 209a-209n and/or controller/processor 224 receives analog or digital data (such as voice data, web data, e-mail, or interactive video game data) from the controller/processor 224. The TX processing circuitry encodes, multiplexes, and/or digitizes the outgoing baseband data to generate processed baseband or IF signals. The transceivers 209a-209n up-converts the baseband or IF signals to RF signals that are transmitted via the antennas 204a-204n.

The controller/processor 224 can include one or more processors or other processing devices that control the overall operation of the AP 101. For example, the controller/processor 224 could control the reception of forward channel signals and the transmission of reverse channel signals by the transceivers 209a-209n in accordance with well-known principles. The controller/processor 224 could support additional functions as well, such as more advanced wireless communication functions. For instance, the controller/processor 224 could support beam forming or directional routing operations in which outgoing signals from multiple antennas 204a-204n are weighted differently to effectively steer the outgoing signals in a desired direction. The controller/processor 224 could also support OFDMA operations in which outgoing signals are assigned to different subsets of subcarriers for different recipients (e.g., different STAs 111-114). Any of a wide variety of other functions could be supported in the AP 101 by the controller/processor 224 including indoor localization of an object using a state machine. In some embodiments, the controller/processor 224 includes at least one microprocessor or microcontroller. The controller/processor 224 is also capable of executing programs and other processes resident in the memory 229, such as an OS. The controller/processor 224 can move data into or out of the memory 229 as required by an executing process.

The controller/processor 224 is also coupled to the backhaul or network interface 234. The backhaul or network interface 234 allows the AP 101 to communicate with other devices or systems over a backhaul connection or over a network. The interface 234 could support communications over any suitable wired or wireless connection(s). For example, the interface 234 could allow the AP 101 to communicate over a wired or wireless local area network or over a wired or wireless connection to a larger network (such as the Internet). The interface 234 includes any suitable structure supporting communications over a wired or wireless connection, such as an Ethernet or RF transceiver. The memory 229 is coupled to the controller/processor 224. Part of the memory 229 could include a RAM, and another part of the memory 229 could include a Flash memory or other ROM.

As described in more detail below, the AP 101 may include circuitry and/or programming for indoor localization of an object using a state machine. Although FIG. 2A illustrates one example of AP 101, various changes may be made to FIG. 2A. For example, the AP 101 could include any number of each component shown in FIG. 2A. As a particular example, an access point could include a number of interfaces 234, and the controller/processor 224 could support routing functions to route data between different network addresses. Alternatively, only one antenna and transceiver path may be included, such as in legacy APs. Also, various components in FIG. 2A could be combined, further subdivided, or omitted and additional components could be added according to particular needs.

FIG. 2B illustrates an example STA 111 according to various embodiments of the present disclosure. The embodiment of the STA 111 illustrated in FIG. 2B is for illustration only, and the STAs 112-114 of FIG. 1 could have the same or similar configuration. However, STAs come in a wide variety of configurations, and FIG. 2B does not limit the scope of this disclosure to any particular implementation of a STA.

The STA 111 includes antenna(s) 205, transceiver(s) 210, a microphone 220, a speaker 230, a processor 240, an input/output (I/O) interface (IF) 245, an input 250, a display 255, and a memory 260. The memory 260 includes an operating system (OS) 261 and one or more applications 262.

The transceiver(s) 210 receives from the antenna(s) 205, an incoming RF signal (e.g., transmitted by an AP 101 of the network 100). The transceiver(s) 210 down-converts the incoming RF signal to generate an intermediate frequency (IF) or baseband signal. The IF or baseband signal is processed by RX processing circuitry in the transceiver(s) 210 and/or processor 240, which generates a processed baseband signal by filtering, decoding, and/or digitizing the baseband or IF signal. The RX processing circuitry sends the processed baseband signal to the speaker 230 (such as for voice data) or is processed by the processor 240 (such as for web browsing data).

TX processing circuitry in the transceiver(s) 210 and/or processor 240 receives analog or digital voice data from the microphone 220 or other outgoing baseband data (such as web data, e-mail, or interactive video game data) from the processor 240. The TX processing circuitry encodes, multiplexes, and/or digitizes the outgoing baseband data to generate a processed baseband or IF signal. The transceiver(s) 210 up-converts the baseband or IF signal to an RF signal that is transmitted via the antenna(s) 205.

The processor 240 can include one or more processors and execute the basic OS program 261 stored in the memory 260 in order to control the overall operation of the STA 111. In one such operation, the processor 240 controls the reception of forward channel signals and the transmission of reverse channel signals by the transceiver(s) 210 in accordance with well-known principles. The processor 240 can also include processing circuitry configured to enable indoor localization of an object using a state machine. In some embodiments, the processor 240 includes at least one microprocessor or microcontroller.

The processor 240 is also capable of executing other processes and programs resident in the memory 260, such as operations for enabling indoor localization of an object using a state machine. The processor 240 can move data into or out of the memory 260 as required by an executing process. In some embodiments, the processor 240 is configured to execute a plurality of applications 262, such as applications to enable indoor localization of an object using a state machine. The processor 240 can operate the plurality of applications 262 based on the OS program 261 or in response to a signal received from an AP. The processor 240 is also coupled to the I/O interface 245, which provides STA 111 with the ability to connect to other devices such as laptop computers and handheld computers. The I/O interface 245 is the communication path between these accessories and the processor 240.

The processor 240 is also coupled to the input 250, which includes for example, a touchscreen, keypad, etc., and the display 255. The operator of the STA 111 can use the input 250 to enter data into the STA 111. The display 255 may be a liquid crystal display, light emitting diode display, or other display capable of rendering text and/or at least limited graphics, such as from web sites. The memory 260 is coupled to the processor 240. Part of the memory 260 could include a random-access memory (RAM), and another part of the memory 260 could include a Flash memory or other read-only memory (ROM).

Although FIG. 2B illustrates one example of STA 111, various changes may be made to FIG. 2B. For example, various components in FIG. 2B could be combined, further subdivided, or omitted and additional components could be added according to particular needs. In particular examples, the STA 111 may include any number of antenna(s) 205 for MIMO communication with an AP 101. In another example, the STA 111 may not include voice communication or the processor 240 could be divided into multiple processors, such as one or more central processing units (CPUs) and one or more graphics processing units (GPUs). Also, while FIG. 2B illustrates the STA 111 configured as a mobile telephone or smartphone, STAs could be configured to operate as other types of mobile or stationary devices.

As discussed earlier, while most of the existing indoor positioning techniques (e.g., Bluetooth and Wi-Fi), suffer from poor accuracy, UWB can provide a robust and accurate indoor localization solution. UWB-based localization techniques generally use TWR or ToA. However, these techniques cannot cater to multiple users at the same time, hence are not very scalable. On the other hand, in DL-TDoA, the target does not directly communicate with the UWB anchors, but only listens to the downlink messages from the anchors. Hence, DL-TDoA not only serves multiple users at the same time, but also does not pose any privacy concerns.

DL-TDoA involves a downlink broadcast technology to position the target. The location of the target is calculated from the differences of arrival times measured on pairs of transmission paths between the target and anchors. The anchors are pre-installed, and time synchronized, and their locations are known to the target. The anchors send signals with timestamps to the target. The target uses the timestamps of the signals received from different anchors to calculate the time difference of arrival from different anchors.

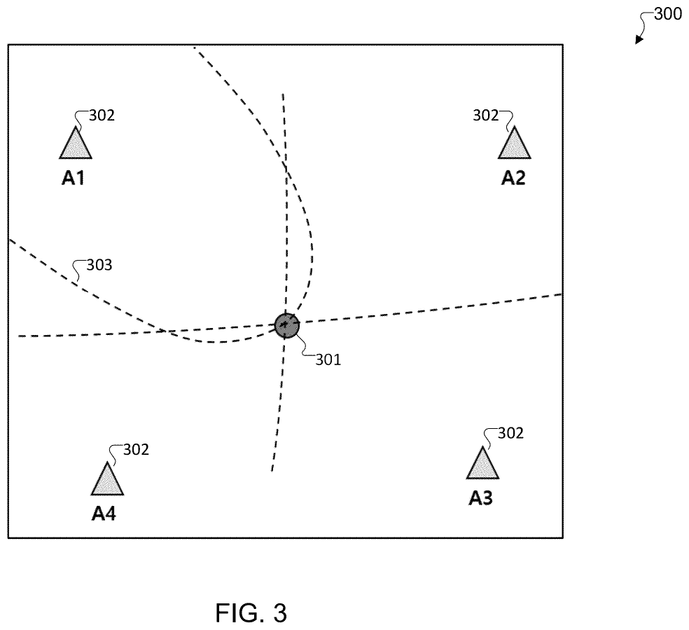

For example, FIG. 3 illustrates an example network 300 in which DL-TDoA can be performed according to various embodiments of the present disclosure. As shown in FIG. 3, the network 300 includes a target 301 disposed in proximity to multiple anchors 302. The target 301 and the anchors 302 could represent various components of the wireless network 100, such as the STA 111 and the AP 101. The location of the target 301 is calculated by determining the point of intersection of the hyperbolas 303 representing the distance differences (that is time difference of arrival multiplied by the speed of light). The target 301 uses measurements from at least four anchors 302 (three DL-TDoA measurements) to calculate its location. Note that the location of the target 301 is calculated at the target 301 itself. The advantage of this technique is that multiple targets 301 can listen to the downlink messages from the anchors 302, making the solution scalable.

Let the distance difference (obtained by multiplying the time difference of arrival with the speed of light) between anchors i and j be represented as dᵢⱼ. The value dᵢⱼ is the difference between the distance of anchor i from the target 301 and the distance of anchor j from the target 301. If anchor k is the initiator or the reference anchor, a ranging round will involve obtaining the distance difference between all anchors 302 and anchor k. For example, if anchor A1 is the reference anchor for the network 300, the measurements obtained in the ranging round will be d₂₁, d₃₁ and d₄₁. The location of the target 301 is the intersection point of the hyperbolas 303 representing these distance differences. The time between two ranging rounds is referred to as the ranging interval.

In practice, due to measurement errors, the hyperbolas 303 often do no intersect at a single point. Multipath also leads to huge errors in the measurements. Hence, an optimizer, for example least squares, Levenberg Marquardt (LM) or gradient descent algorithm, can be used to calculate the location of the target 301. However, these solutions need at least 3 UWB DL-TDoA measurements to localize the target 301. Hence, although UWB is capable of providing a highly accurate solution under controlled environments, in a more practical scenario, the quality and quantity of received measurements may be impacted by multipath and occlusion.

To address these and other issues, this disclosure provides systems and methods for indoor localization of an object using a state machine. As described in more detail below, the disclosed embodiments feature a sensor-assisted solution to perform robust and accurate indoor localization using UWB DL-TDoA measurements. That is, the disclosed embodiments combine UWB DL-TDoA measurements with motion sensor measurements to provide a UWB localization technique that is accurate (e.g., by also taking into account sensor information) and simultaneously robust to multipath and occlusion.

Note that while some of the embodiments discussed below are described in the context of smart phones, these are merely examples. It will be understood that the principles of this disclosure may be implemented in any number of other suitable contexts or systems, including other fixed or portable electronic devices (e.g., tablets, laptops, and the like).

Before describing the disclosed techniques in detail, it may be helpful to provide the following contextual information.

### Pedestrian Dead Reckoning/Step and Heading System

Dead reckoning is a method of estimating the position of a moving object using the object's last known position and adding incremental displacements on top of that. Pedestrian dead reckoning, or PDR, refers specifically to the scenario where the object in question is a pedestrian walking in an indoor or outdoor space. With the proliferation of sensors inside smart devices (e.g., smartphones, tablets, smart watches, and the like), PDR has naturally matured to supplement wireless positioning technologies that have been long supported by these devices, such as Wi-Fi, cellular service, and UWB. The inertial measurement unit (IMU) is a device that combines numerous sensors with functional differences. For example, the accelerometer measures linear acceleration, the gyroscope measures angular velocity, and the magnetometer measures the strength and direction of the magnetic field. These three sensors can detect motion and estimate its velocity, i.e., speed and heading. PDR is also referred to as the Step and Heading (SH) system.

### Extended Kalman Filter

A Kalman filter recursively estimates the state of a dynamical system from a sequence of measurements obtained over time and an assumption of state trajectory. It assumes an underlying system that is modeled by two linear equations: a state transition/motion equation and a measurement/observation equation. The motion equation describes the evolution of the state of the system and relates the current state to a previous state as follows:

$${x}_{k} = {A}_{k} {x}_{k - 1} + {B}_{k} {u}_{k} + {v}_{k}$$

where xₖ is the current state, xₖ₋₁ is the last state, Aₖ is the state transition matrix, uₖ is the current input, Bₖ is the control/input matrix, and vₖ˜N(0, Qₖ) is the process noise which represents uncertainty in state.

The measurement equation relates the current observation to the current state as follows:

$${y}_{k} = {H}_{k} {x}_{k} + {w}_{k}$$

where yₖ is the latest observation, Hₖ is the observation matrix, and wₖ˜N(0, Rₖ) is the observation noise.

At each time index k, the Kalman filter estimates the state of the system by applying a prediction step followed by an update step. The outcome of these two steps is the state estimate \hat{x}ₖ at time index k and its covariance matrix Pₖ, which are in turn used to estimate the states at later points in time.

In the prediction step, the Kalman filter predicts the current state \hat{x}_{k|k-1} (a priori estimate) from the most recent state estimate \hat{x}ₖ₋₁, its covariance Pₖ₋₁, and any inputs using the motion equation as follows:

$${\hat{x}}_{k \vert k - 1} = {A}_{k} {\hat{x}}_{k - 1} + {B}_{k} {u}_{k} \\ {P}_{k \vert k - 1} = {A}_{k} {P}_{k} {A}_{k}^{*} + {Q}_{k}$$

In the update step, the Kalman filter uses the latest observation to update its prediction and obtain the (a posteriori) state estimate \hat{x}ₖ and its covariance Pₖ as follows:

$${\hat{x}}_{k} = {\hat{x}}_{k \vert k - 1} + {K}_{k} ( {y}_{k} - {H}_{k} {\hat{x}}_{k \vert k - 1} )$$

$${P}_{k} = ( 1 - {K}_{k} {H}_{k} ) {P}_{k \vert k - 1}$$

where Kₖ is the Kalman gain and is a function of the a priori estimate covariance P_{k|k-1}, observation matrix Hₖ, and observation noise covariance matrix Rₖ.

The extended Kalman filter (EKF) is a work-around to handle non-linearities in the motion or measurement models. If the motion or measurement equations are not linear, the Kalman filter could not be used unless these equations are linearized. Consider the following non-linear motion and measurement equations:

$${x}_{k} = {f}_{k} ( {x}_{k - 1} , {u}_{k} ) + {v}_{k} \\ {y}_{k} = {h}_{k} ( {x}_{k} ) + {w}_{k}$$

where fₖ and hₖ are non-linear functions. The EKF applies the predict and update steps as follows:

For the EKF, the prediction step includes the following:

$${\hat{x}}_{k \vert k - 1} = {f}_{k} ( {\hat{x}}_{k - 1} , {u}_{k} ) \\ {P}_{k \vert k - 1} = {F}_{k} {P}_{k} {F}_{k}^{*} + {Q}_{k}$$

$${where {F}_{k} = \frac{\partial {f}_{k} ( x , u )}{\partial x} \vert}_{x = {\hat{x}}_{k - 1} , u = {u}_{k}}$$

For the EKF, the update step includes the following:

$${\hat{x}}_{k} = {\hat{x}}_{k \vert k - 1} + {K}_{k} ( {y}_{k} - {H}_{k} {\hat{x}}_{k \vert k - 1} ) \\ {P}_{k} = ( I - {K}_{k} {H}_{k} ) {P}_{k \vert k - 1}$$

$${where {H}_{k} = \frac{\partial {h}_{k} ( x )}{\partial x} \vert}_{x = {\hat{x}}_{k - 1}}$$

The state estimate \hat{x}ₖ and its covariance Pₖ are propagated to track the state of system.

In the context of localization, the state is the target 2D location. In the context of UWB DL-TDoA based indoor localization, the observations are UWB distance difference measurements, which are calculated from TDoA measurements by multiplying it with the speed of light.

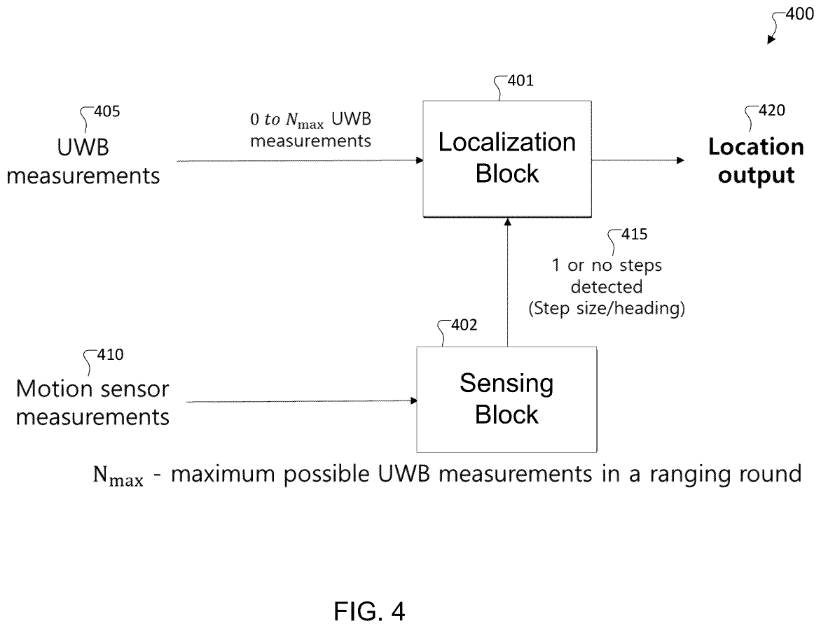

FIG. 4 illustrates an example system 400 for performing indoor localization according to various embodiments of the present disclosure. The system 400 includes a multi-model EKF state machine that uses UWB measurements and sensor data and switches states depending on the availability of UWB measurements and detection of steps. The system 400 also includes an outlier removal technique to get rid of measurements impacted by multipath. The embodiment of the system 400 shown in FIG. 4 is for illustration only. Other embodiments of the system 400 could be used without departing from the scope of this disclosure. For ease of explanation, the system 400 will be described as being implemented in the network 300 of FIG. 3, such as in the target 301. However, the system 400 could be implemented in any other suitable device(s) or system(s).

As shown in FIG. 4, the system 400 includes a localization block 401 and a sensing block 402. The localization block 401 receives UWB measurements 405 from one or more anchors 302. In some embodiments, the UWB measurements 405 include UWB DL-TDoA measurements. If the localization block 401 receives a sufficient number (e.g., at least three) of UWB DL-TDoA measurements, the localization block 401 uses an optimizer along with a tracking filter, or a tracking filter alone, to track the location 420 of the target 301. However, it is possible to encounter cases where no UWB measurements 405 are received by the localization block 401, either due to occlusion or due to the target 301 leaving the coverage area of the anchors 302. In such cases, the state of the tracking filter is not updated. It is also possible that the UWB measurements 405 received by the target are of poor quality, possibly impacted by multipath. In such scenarios, the tracking filter may not generate the correct output. In order to deal with scenarios of no UWB measurements 405 or poor quality UWB measurements 405, the localization block 401 uses information from the sensing block 402 to track the target 301.

The sensing block 402 uses motion sensor measurements 410 to detect steps as the user walks. The length/size and direction/heading of the steps are calculated using these measurements and fed to the localization block 401 as step information 415. Step detection and step size and heading calculation can be performed using a combination of motion sensors, which can include an accelerometer, magnetometer, and gyroscope, such as those that are part of an IMU. In one example, the variations in the motion sensor measurements 410 can be used to detect the steps, while the peaks and dips in the measurements can be used to calculate the step size and heading.

The localization block 401 takes the UWB measurements 405, whenever available, and the step information 415, whenever provided by the sensing block 402, to calculate the location 420 of the target 301. In some embodiments, the localization block 401 uses a multi-model tracking filter, EKF−RW+SH, that includes a motion model. The motion model can be represented as a state machine that switches between multiple states, including a random walk EKF (EKF-RW) state and a step-and-heading EKF (EKF-SH) state, depending on the availability of the UWB measurements 405 and the detection of steps in the step information 415 from the sensing block 402. The EKF−RW+SH tracking filter runs after every ranging interval, which is the time interval at which UWB measurements are expected to be received (e.g., 200 ms). The motion model switches its state depending on whether a UWB measurement 405 is received within a ranging interval and whether a step is detected in the step information 415 during a ranging interval.

### Random Walk EKF (EKF-RW)

Random walk EKF is one of the states of the state machine discussed above. A random walk EKF estimates the state xₖ [xₖ yₖ]^{T} by using a motion model given as:

$${x}_{k} = {x}_{k - 1} + {v}_{k} \qquad ( 1 )$$

where (xₖ, yₖ) represents the 2D location of the target 301 and xₖ₋₁ is the previous state of the EKF representing the previous 2D location of the target 301. The term vₖ˜N(0, Qₖ) represents the process noise, which can be given by the following:

$${Q}_{k} = [ \begin{matrix}{σ}_{P}^{2} Δ {t}^{2} & 0 \\ 0 & {σ}_{P}^{2} Δ {t}^{2}\end{matrix} ] \qquad ( 2 )$$

where Δt=tₖ−tₖ₋₁ is the time difference between consecutive steps and σ_{P}² is the variance in the speed of the target 301.

The measurement model maps the current UWB measurements 405, which can include the distance difference measurements (dᵢⱼ) from anchor pair i and j (among the anchors 302), to the current state using the measurement equation:

$${d}_{ij} = d ( {x}_{k} , {x}_{i} , {x}_{j} ) + {w}_{k} \qquad ( 3 )$$

Here, dᵢⱼ represents the difference in distance dᵢ of the target 301 from anchor i and its distance dⱼ from the anchor j. The term dᵢⱼ is a measurement obtained by multiplying the TDoA from anchors i and j with the speed of light. In Equation (3), xᵢ and xⱼ represent the 2D location of the anchors i and j, respectively, and wₖ˜(μₖ, Rₖ) represents the measurement noise.

Considering a fixed value h_{A} for the height of the anchors i and j and approximate value h_{T} for the height of the target 301, the mapping between the state and measurements is given as:

$$d ( {x}_{k} , {x}_{i} , {x}_{j} ) = {d}_{i} - {d}_{j} = \sqrt{{( {x}_{k} - {x}_{i} )}^{2} + {( {y}_{k} - {y}_{i} )}^{2} + {( {h}_{T} - {h}_{A} )}^{2}} - \sqrt{{( {x}_{k} - {x}_{j} )}^{2} + {( {y}_{k} - {y}_{j} )}^{2} + {( {h}_{T} - {h}_{A} )}^{2}} \qquad ( 4 )$$

Equation (3) is linearized into the following equation:

$${y}_{k} = {H}_{k} {x}_{k} + {w}_{k} \qquad ( 5 )$$

where yₖ is a vector of measurements dᵢⱼ available from different pairs of anchors 302, and Hₖ is the Jacobian matrix obtained by taking the partial derivative of dᵢⱼ with the state vector. The row vector of Hₖ corresponding to the measurement dᵢⱼ is given as:

$$[ \begin{matrix}\frac{{x}_{k} - {x}_{i}}{{d}_{i}} - \frac{{x}_{k} - {x}_{j}}{{d}_{j}} & \frac{{y}_{k} - {y}_{i}}{{d}_{i}} - \frac{{y}_{k} - {y}_{j}}{{d}_{j}}\end{matrix} ] .$$

The prediction and update steps of EKF-RW based on the motion model and measurement model described above are as follows:

### Prediction Step:

$${\hat{x}}_{k \vert k - 1} = {\hat{x}}_{k - 1}$$

$${P}_{k \vert k - 1} = {P}_{k} + {Q}_{k}$$

### Update Step:

$${\hat{x}}_{k} = {\hat{x}}_{k \vert k - 1} + {K}_{k} ( {y}_{k} - {H}_{k} {\hat{x}}_{k \vert k - 1} )$$

$${P}_{k} = ( I - {K}_{k} {H}_{k} ) {P}_{k \vert k - 1} .$$

### Step and Heading EKF (EKF-SH)

Step and Heading EKF is another one of the states of the state machine discussed above. A step and heading EKF combines the UWB measurements with the steps of the user to calculate the location of the target 301. It estimates the state xₖ=[xₖ yₖ]^{T} which represents the location of the target 301 by using the following motion model:

$${x}_{k} = {x}_{k - 1} + {S}_{k} [ \begin{matrix}cos {θ}_{k} \\ sin {θ}_{k}\end{matrix} ] + {v}_{k} \qquad ( 6 )$$

where Sₖ represents the step length/size and θₖ represents the step heading/direction. Here vₖ˜N(0, Qₖ) represents the step error.

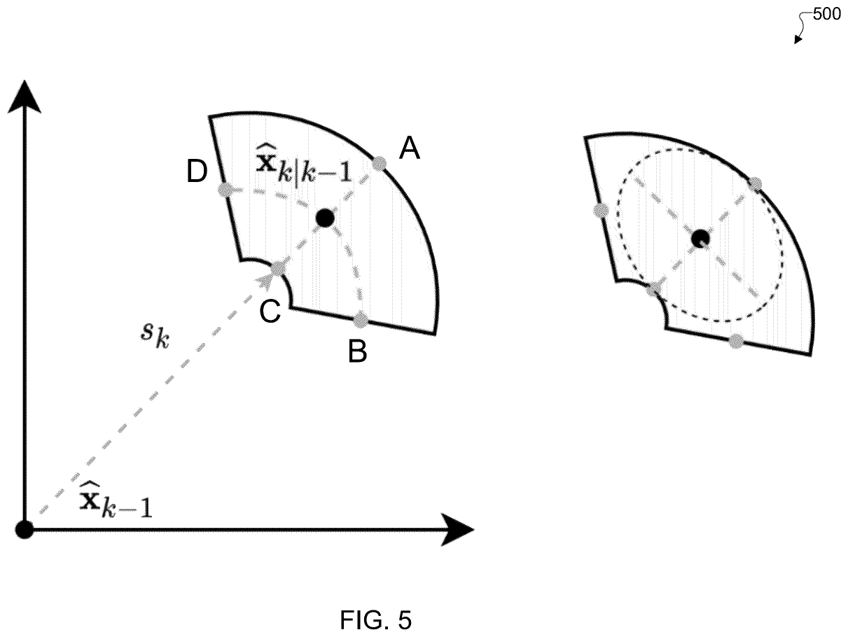

The step error is approximated by using a step size error σs and a heading error σ_{θ} along with the recent history of position estimates. FIG. 5 illustrates an example error model 500 for EKF-SH that can be used in the system 400 according to various embodiments of the present disclosure. If \hat{x}=(\hat{x}, ŷ) represents the most recent location estimate, and S and θ represent the latest step size and heading, the coordinates of points A, B, C, D shown in FIG. 5 can be computed as:

$$A = ( \hat{x} + ( S + {σ}_{s} ) \cdot cos θ , \hat{y} + ( S + {σ}_{s} ) \cdot sin θ ) \qquad ( 7 )$$

$$B = ( \hat{x} + S \cdot cos ( θ - {σ}_{θ} ) , \hat{y} + S \cdot sin ( θ - {σ}_{θ} ) ) \qquad ( 8 )$$

$$C = ( \hat{x} + ( S - {σ}_{s} ) \cdot cos θ , \hat{y} + ( S - {σ}_{s} ) \cdot sin θ ) \qquad ( 9 )$$

$$D = ( \hat{x} + S \cdot cos ( θ + {σ}_{θ} ) , \hat{y} + S \cdot sin ( θ + {σ}_{θ} ) ) \qquad ( 10 )$$

The variance of the horizontal and vertical errors σ_{X}² and σ_{Y}² and the covariance σ_{XY} for the error segment are computed as follows:

$${σ}_{X}^{2} = s i {n}^{2} θ \cdot {( \frac{\overline{DB}}{2} )}^{2} + {cos}^{2} θ \cdot {( \frac{\overline{AC}}{2} )}^{2} \qquad ( 11 )$$

$${σ}_{Y}^{2} = c o {s}^{2} θ \cdot {( \frac{\overline{DB}}{2} )}^{2} + {sin}^{2} θ \cdot {( \frac{\overline{AC}}{2} )}^{2} \qquad ( 12 )$$

$${σ}_{XY} = ( {( \frac{\overline{DB}}{2} )}^{2} - {( \frac{\overline{AC}}{2} )}^{2} ) \cdot cos ( θ ) sin ( θ ) \qquad ( 13 )$$

The process noise covariance matrix Qₖ is thus obtained as:

$${Q}_{k} = [ \begin{matrix}{σ}_{X}^{2} & {σ}_{XY} \\ {σ}_{XY} & {σ}_{Y}^{2}\end{matrix} ] \qquad ( 14 )$$

The measurement model used for EKF-SH is the same as the one used for EKF-RW.

The prediction and update steps of EKF-SH based on the motion model and measurement model described above are as follows:

### Prediction Step:

$${\hat{x}}_{k \vert k - 1} = {\hat{x}}_{k - 1} + {S}_{k} [ \begin{matrix}cos {θ}_{k} \\ sin {θ}_{k}\end{matrix} ]$$

$${P}_{k \vert k - 1} = {P}_{k} + {Q}_{k}$$

### Update Step:

$${\hat{x}}_{k} = {\hat{x}}_{k \vert k - 1} + {K}_{k} ( {y}_{k} - {H}_{k} {\hat{x}}_{k \vert k - 1} )$$

$${P}_{k} = ( I - {K}_{k} {H}_{k} ) {P}_{k \vert k - 1}$$

As discussed above, new UWB measurements 405 are not always available at the end of each ranging round. Some environmental factors (such as occlusion or leaving the convex hull) can lead to complete or partial loss of UWB measurements 405. A EKF-RW tracking filter requires measurements to execute the update step. Hence, the EKF-RW tracking filter is not sufficient by itself to localize the target 301 in such unavoidable scenarios. Similarly, EKF-SH requires steps in its motion model. Generally, the rate of UWB measurements 405 is faster than the rate of user steps. Stated differently, in the time that elapses while a user takes a step, the localization block 401 may receive multiple UWB measurements 405. Hence, only using EKF-SH could provide location estimates at a much slower rate and the estimates could appear uneven. Thus, the system 400 combines both EKF-RW and EKF-SH models into the EKF−RW+SH state machine, which is a multi-model localization state machine.

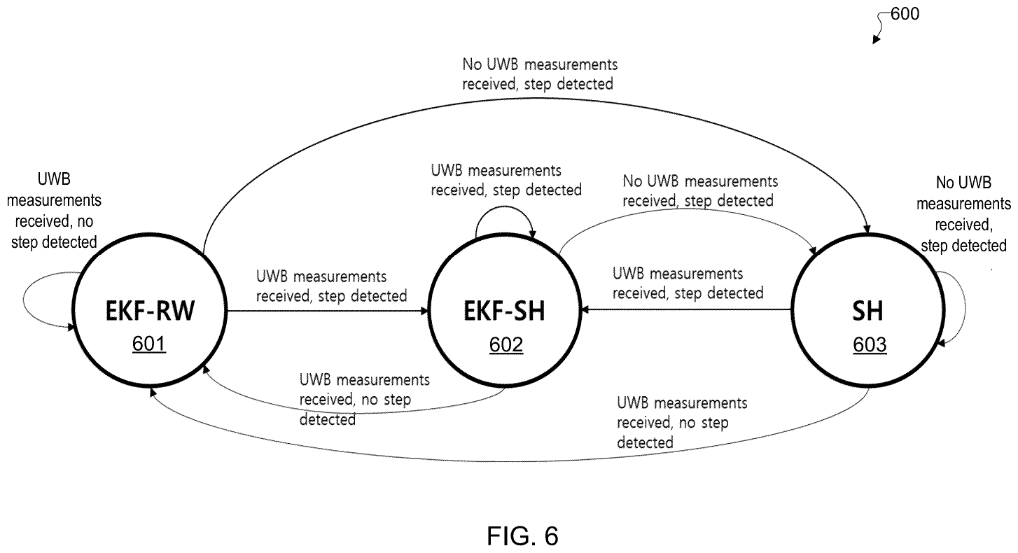

FIG. 6 illustrates an example EKF−RW+SH state machine 600 for use with the system 400 according to various embodiments of the present disclosure. As shown in FIG. 6, the EKF−RW+SH state machine 600 switches between different states 601-603 depending on whether UWB measurements 405 are received and whether a step is detected in the received step information 415. The localization block 401 executes the EKF−RW+SH state machine 600 at the end of every ranging round. The ranging round lasts for a fixed time interval, known as the ranging interval, during which the ranging measurements are fetched as per the round configuration of ranging. It is possible to not receive any UWB measurements 405 by the end of the ranging interval. Also, since the user steps are detected at a slower rate than the UWB measurements 405, it is possible to have no steps detected in the duration of a ranging round. Hence, four possible situations in each ranging round that drive the EKF−RW+SH state machine 600 are:
UWB measurement 405 received, but no step detected in the step information 415
UWB measurement 405 received, and a step detected in the step information 415
No UWB measurement 405 received, but a step detected in the step information 415
No UWB measurement 405 received, and no step detected in the step information 415.

As shown in FIG. 6, the different states 601-603 of the EKF−RW+SH state machine 600 include the following:

EKF-RW state 601: The state machine 600 goes to this state when UWB measurements 405 are received, but no step is detected in the step information 415 at the end of the ranging round.

EKF-SH state 602: This state is entered when UWB measurements 405 are received, and a step is detected in the step information 415 at the end of the ranging round.

SH state 603: This is the state which is run when UWB measurements 405 are not obtained, but a step is detected in the step information 415 during the ranging round. The SH state 603 can be considered similar to the EKF-SH state 602, but without the update step, that is just running the prediction step of the EKF-SH state 602.

In some embodiments, when no UWB measurements are obtained and no step is detected for the ranging round, then the state of the EKF−RW+SH state machine 600 remains unchanged. In some embodiments, the initial state of the EKF−RW+SH state machine 600 is the EKF-RW state 601.

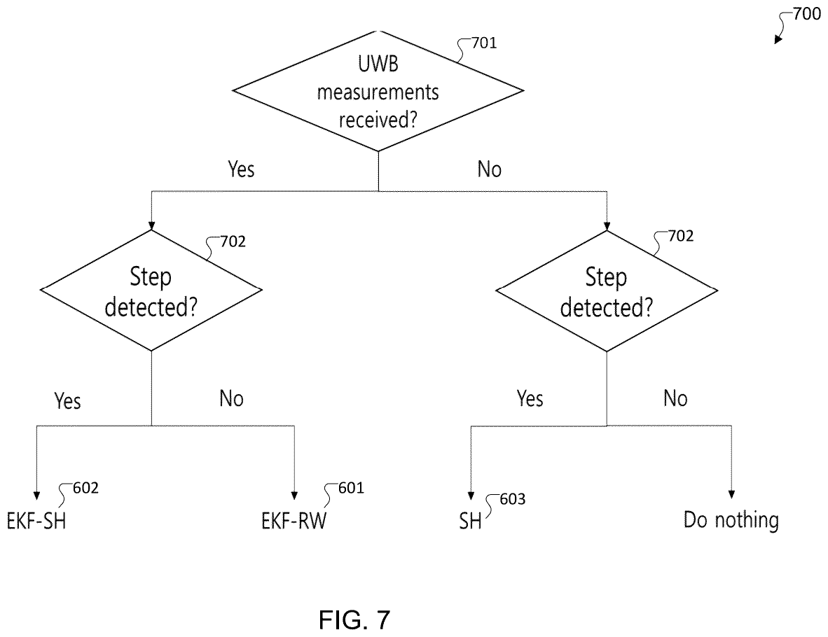

FIG. 7 illustrates an example process 700 for determining the state of the EKF−RW+SH state machine 600 at the end of each ranging round, according to various embodiments of the present disclosure. As shown in FIG. 7, the process 700 starts with operation 701, in which the localization block 401 determines if any UWB measurements 405 have been received from one or more anchors 302. Next, at operation 702, the localization block 401 determines if one or more steps are detected in the step information 415 during the ranging round. Depending on the results of operation 701 and operation 702, the EKF−RW+SH state machine 600 may go to the EKF-RW state 601, go to the EKF-SH state 602, go to the SH state 603, or remain unchanged.

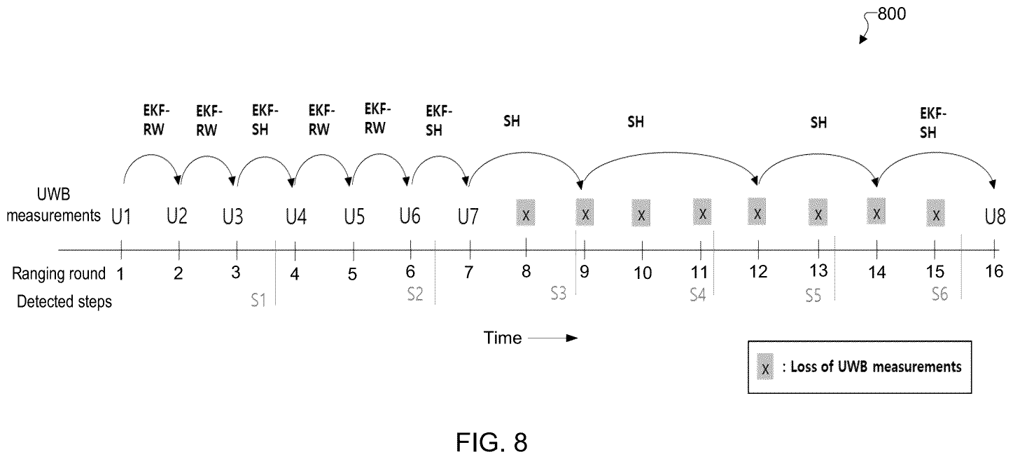

FIG. 8 illustrates an example timeline 800 showing EKF−RW+SH state changes for an example set of UWB measurement receptions and step detections according to various embodiments of the present disclosure. As shown in FIG. 8, the timeline 800 includes a series of ranging rounds (numbered 1 through 16), and each tick along the time axis represents the end of a ranging round. As stated above, the state of the EKF−RW+SH state machine 600 is determined at the end of each ranging round, such as per the process 700 in FIG. 7.

At the ends of the 1^{st}, 2^{nd} and 3^{rd} ranging rounds, the localization block 401 receives one or more UWB measurements 405, but no step is detected in the step information 415 received during each ranging round. Thus, the EKF−RW+SH state machine 600 enters (or stays in) the EKF-RW state 601. At the end of the 4^{th} ranging round, the localization block 401 receives one or more UWB measurements 405, and a step (S1) is detected in the step information 415. Thus, the EKF−RW+SH state machine 600 enters the EKF-SH state 602. At the ends of the 5^{th} and 6^{th} ranging rounds, the localization block 401 receives one or more UWB measurements 405, but no step is detected in the step information 415. Thus, the EKF−RW+SH state machine 600 enters (or stays in) the EKF-RW state 601. At the end of the 7^{th} ranging round, the localization block 401 receives one or more UWB measurements 405, and a step (S2) is detected in the step information 415. Thus, the EKF−RW+SH state machine 600 enters the EKF-SH state 602.

A location output 420 is obtained at the end of every ranging round when UWB measurements 405 are present. That is, the localization block 401 can generate a location output 420 at the end of the 1^{st} through 7^{th} ranging rounds, since at least one UWB measurement 405 is received for those ranging rounds. When UWB measurements 405 are lost (i.e., not received), a location output 420 is generated at the end of only those ranging rounds during which a step is detected. For example, in the timeline 800, no UWB measurements 405 are received for the 8^{th} 15^{th} ranging rounds. However, steps (S3, S4, and S5) are detected during the 9^{th}, 12^{th}, and 14^{th} ranging rounds, so a location output 420 can be generated at the ends of those ranging rounds.

When the EKF−RW+SH state machine 600 enters the EKF-SH state 602 or the SH state 603 (that is, when a step is detected during the ranging round), the step length is calculated from the last step detection. However, the EKF state update is since the last state of EKF. Hence, if the entire step length is added to the last state of EKF as per the EKF-SH state equation shown in Equation (6), it may cause an overshooting of the trajectory. Hence, in some embodiments, Equation (6) can be modified to add a fraction of a step to the last state:

$${x}_{k} = {x}_{k - 1} + {f}_{k} {S}_{k} [ \begin{matrix}cos {θ}_{k} \\ sin {θ}_{k}\end{matrix} ] + {ν}_{k} \qquad ( 15 )$$

where Sₖ represent the step detected during kth ranging round and fₖ represents the fraction. Let the exact timestamp of step Sn be t_{S}_{ₙ} and the timestamp of the previous step be t_{S}_{ₙ₋₁}. Then, the fraction fₖ can be determined by the following:

$${f}_{k} = \frac{{t}_{k} - {t}_{k - 1}}{{t}_{{S}_{n}} - {t}_{{S}_{n - 1}}} \qquad ( 16 )$$

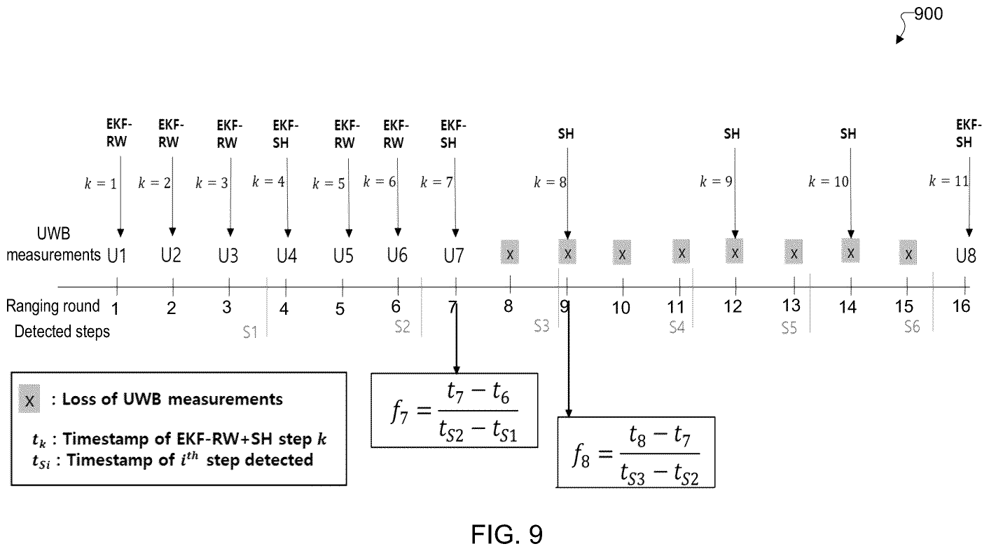

FIG. 9 illustrates an example timeline 900 in which a fraction is calculated for one or more EKF−RW+SH steps when a step is detected, according to various embodiments of the present disclosure. As shown in FIG. 9, a fraction f₇ for the 7^{th} EKF−RW+SH step (k=7), which occurs after the S2 step, can be determined as:

$${f}_{7} = \frac{{t}_{7} - {t}_{6}}{{t}_{S 2} - {t}_{S 1}} .$$

Similarly, a fraction f₈ for the 8^{th} EKF−RW+SH step (k=8), which occurs after the S3 step, can be determined as:

$${f}_{8} = \frac{{t}_{8} - {t}_{7}}{{t}_{S 3} - {t}_{S 2}} .$$

As discussed above, as shown in FIG. 7, when no UWB measurement 405 is received and no step is detected in the step information 415, then the state of the EKF−RW+SH state machine 600 remains unchanged. However, in some other embodiments, another state, referred to as “extrapolated step-and-heading” (“SH-Ext”), can be entered when no UWB measurement 405 is received, and no step is detected. The SH-Ext state uses the last detected step length to extrapolate the step and obtain the step length for the current ranging round, such as given by the following:

$$Extrapolated step length = \frac{{t}_{k} - {t}_{k - 1}}{{t}_{{S}_{n}} - {t}_{{S}_{n - 1}}} * {SL}_{Sn}$$

where SL_{Sn} is the step length of the n^{th} step detected. The heading used is the same as the heading of the last detected step. So, in such embodiments, a localization output is generated at the end of every ranging round. For each ranging round, the state of the EKF−RW+SH state machine 600 is decided as per FIG. 7, except that the “do nothing” step is now “SH-Ext”.

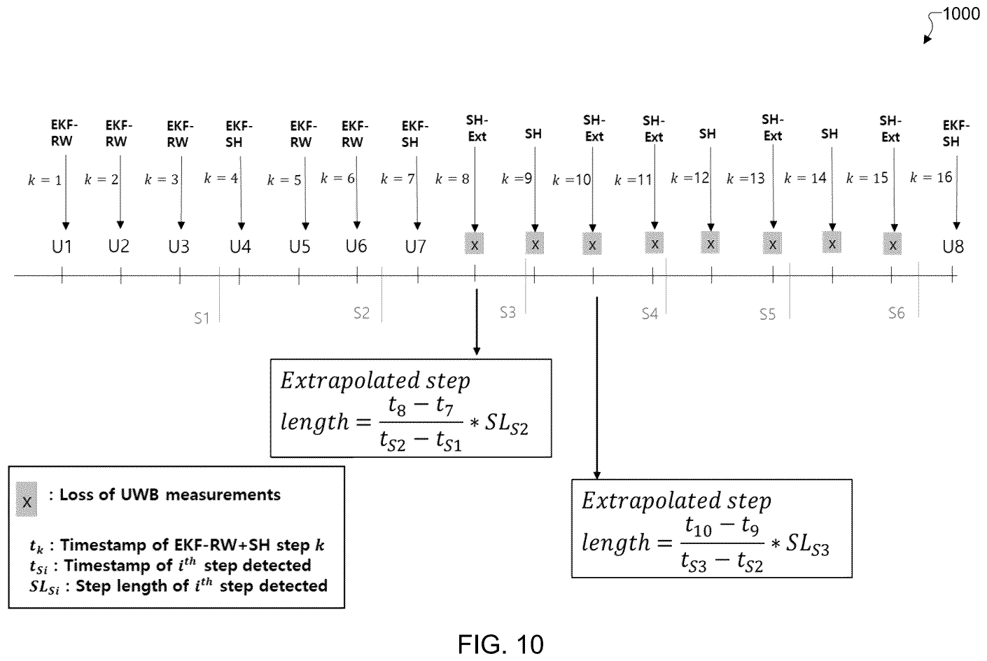

FIG. 10 illustrates an example timeline 1000 in which the last detected step length is extrapolated in the absence of UWB measurements and step detection, according to various embodiments of the present disclosure. As shown in FIG. 10, step lengths are extrapolated at the 8^{th} EKF−RW+SH step (k=8) and at the 10^{th} EKF−RW+SH step (k=10).

In some embodiments, when UWB measurements 405 are received and a step is detected, instead of switching to the EKF-SH state 602, the EKF−RW+SH state machine 600 can switch to another state referred to as “weighted-EKF.” In weighted-EKF, instead of using the output of EKF-SH as the location output 420, the state update for both EKF-RW and EKF-SH is performed, and the location output 420 is the weighted sum of EKF-SH and EKF-RW, which can be determined by the following:

$${x}_{k} = α \cdot {x}_{{k}_{EKF - RW}} + ( 1 - α ) \cdot {x}_{{k}_{EKF - SH}} \qquad ( 17 )$$

where α represents the selected weight value.

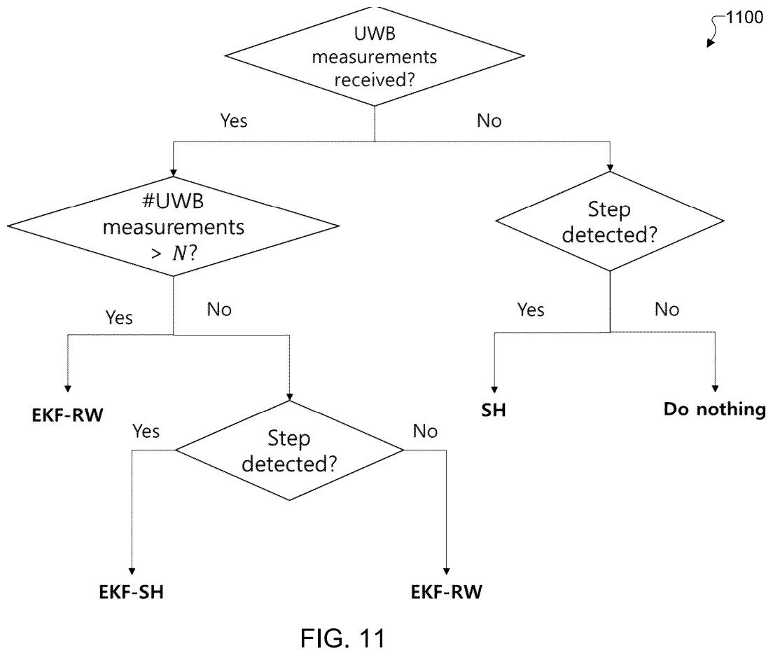

Whenever UWB measurements 405 are available, they can be more reliable than the step size and heading input. Hence, in some embodiments, the localization block 401 keeps using EKF-RW as long as UWB measurements 405 received at the end of a ranging round are above a threshold N (e.g., N∈[3,4,5]). If the number of measurements fall below N, only then the state switching to EKF-SH or SH occurs. When the number of measurements is below N and a step is detected, the state is switched to EKF-SH. When no measurements are received and a step is detected, the state is switched to SH. FIG. 11 illustrates an example process 1100 for such embodiments where EKF−RW+SH is dominated by UWB measurements.

### Outlier Removal

In some embodiments, the localization block 401 performs an outlier removal technique to identify and remove bad UWB measurements to enhance the localization performance. Outlier removal can be performed in between the prediction and update steps of EKF−RW+SH whenever the localization block 401 receives UWB measurements 405. Whenever UWB measurements 405 are available, regardless of the state of EKF−RW+SH state machine 600 (i.e., EKF-RW state or EKF-SH state), the prediction step is first executed to obtain an initial estimate of the next location of the target. The prediction step depends on the availability of steps. If a step is detected, the EKF-SH motion model is used for prediction. However, if no step is detected, the EKF-RW motion model is used for prediction. Outlier removal is executed only if UWB measurements 405 are available.

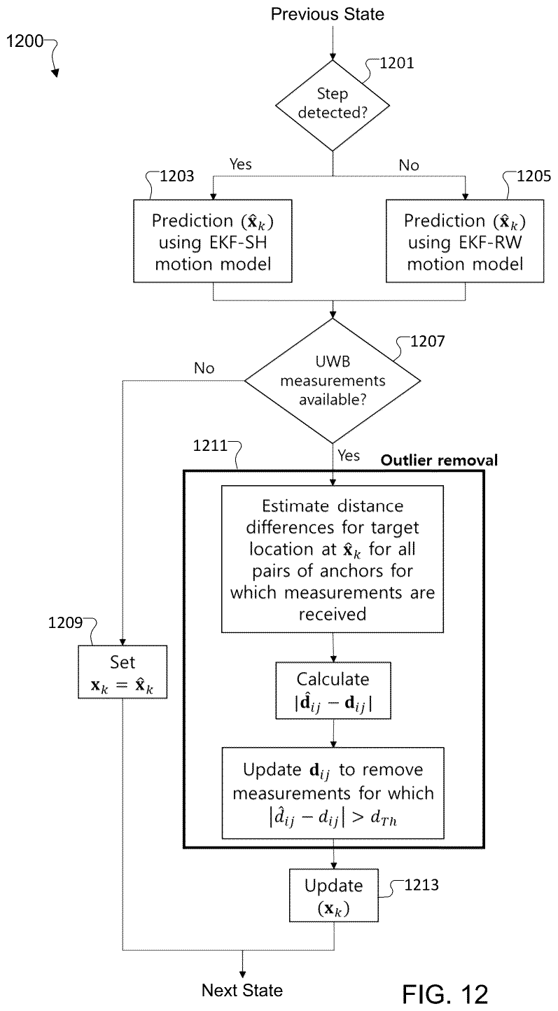

FIG. 12 illustrates an example process 1200 for outlier removal and EKF−RW+SH according to various embodiments of the present disclosure. As shown in FIG. 12, the process 1200 starts with operation 1201, in which the localization block 401 determines if a step is detected in the step information 415. If a step is detected, then at operation 1203, the localization block 401 executes the prediction step using the EKF-SH motion model. If no step is detected, then at operation 1205, the localization block 401 executes the prediction step using the EKF-RW motion model. Thus, using either operation 1205 or 1207, the localization block 401 predicts the next location of the target 301 for all pairs of anchors 302.

At operation 1207, the localization block 401 determines if UWB measurements 405 are available. If not, then at operation 1209, the localization block 401 sets xₖ=\hat{x}ₖ (i.e., the next state is set to be the same as the predicted state). However, if UWB measurements 405 are available, then at operation 1211, the localization block 401 performs the outlier removal technique.

For this predicted location, the localization block 401 calculates an estimate of the distance difference measurements or dᵢⱼ's for all pairs of anchors 302 for which the UWB measurements 405 are received. The estimated distance differences, \hat{d}ᵢⱼ, are compared against the measured distance differences, dᵢⱼ. If the absolute difference between the estimated and measured distance difference |\hat{d}ᵢⱼ−\hat{d}ᵢⱼ| is above a certain predefined threshold d_{Th} (e.g., d_{Th}=1, 2, or 3 meters), that distance difference measurement is labeled as an outlier, and is removed from consideration so as to be not used in the update step of multi-model EKF. At operation 1213, the localization block 401 performs the update step of multi-model EKF.

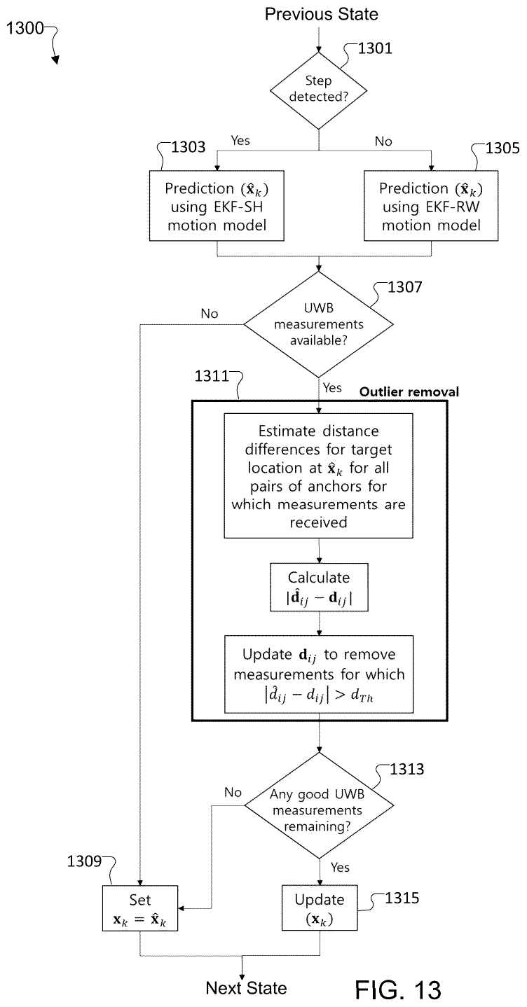

Sometimes it is possible that all the received UWB measurements 405 are outliers. In such cases, before performing the outlier removal, UWB measurements 405 are available, but after the outlier removal is performed, vector dᵢⱼ is empty as all the measurements are removed as outliers. To address such cases, the process 1200 can be modified as shown in FIG. 13.

FIG. 13 illustrates another example process 1300 for outlier removal and EKF−RW+SH according to various embodiments of the present disclosure. As shown in FIG. 13, the process 1300 includes multiple operations that are the same as, or similar to, corresponding operations in the process 1200. For example, operations 1301-1311 are the same as, or similar to, operations 1201-1211 in FIG. 12.

After the localization block 401 performs outlier removal in operation 1311, the localization block 401 performs operation 1313 to check whether or not any good UWB measurements 405 are left after the outlier removal is performed. If no good UWB measurements 405 are available, update of EKF−RW+SH state is not done and the localization block 401 sets xₖ=\hat{x}ₖ at operation 1309 (i.e., the next state is set to be the same as the predicted state). In such cases, the error covariance matrix of EKF−RW+SH can be set to a high value to reflect less confidence on the state estimate in the absence of measurements. However, if good UWB measurements 405 still remain, then at operation 1315, the localization block 401 performs the update step of multi-model EKF.

Although FIGS. 4 through 13 illustrate example techniques for indoor localization of an object using a state machine and related details, various changes may be made to FIGS. 4 through 13. For example, various components in FIGS. 4 through 13 could be combined, further subdivided, or omitted and additional components could be added according to particular needs. In addition, while shown as a series of steps, various operations in FIGS. 4 through 13 could overlap, occur in parallel, occur in a different order, or occur any number of times. In another example, steps may be omitted or replaced by other steps.

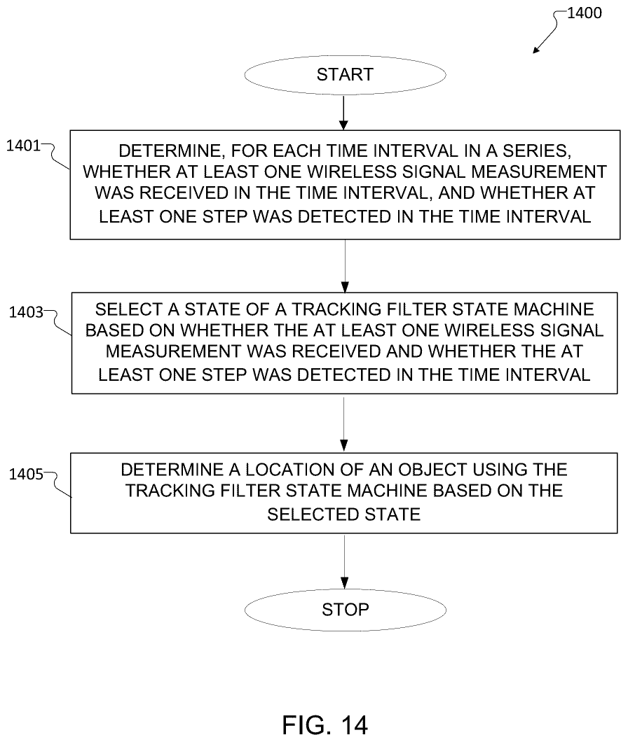

FIG. 14 illustrates a flow chart of a method 1400 for indoor localization of an object using a state machine according to various embodiments of the present disclosure, as may be performed by one or more components of the network 300 (e.g., the target 301 or the anchors 302). The embodiment of the method 1400 shown in FIG. 14 is for illustration only. One or more of the components illustrated in FIG. 14 can be implemented in specialized circuitry configured to perform the noted functions or one or more of the components can be implemented by one or more processors executing instructions to perform the noted functions.

As illustrated in FIG. 14, the method 1400 begins at step 1401. At step 1401, an electronic device determines, for each time interval in a series of time intervals, (i) whether at least one wireless signal measurement was received in the time interval, and (ii) whether at least one step was detected in the time interval. Each wireless signal measurement is associated with a pair of anchors. In some embodiments, the at least one wireless signal measurement comprises UWB DL-TDoA measurements. This could include, for example, the target 301 determining if any UWB measurements 405 were received in the ranging round, and if any step was detected in the step information 415 during the ranging round, such as shown in FIG. 7.

At step 1403, the electronic device selects a state of a tracking filter state machine based on whether the at least one wireless signal measurement was received in the time interval and whether the at least one step was detected in the time interval. This could include, for example, the target 301 selecting a first state (e.g., an EKF-RW state) when at least one wireless signal measurement was received, but no step was detected in the time interval; selecting a second state (e.g., an EKF-SH state) when at least one wireless signal measurement was received and at least one step was detected in the time interval, or selecting a third state (e.g., a SH state) when no wireless signal measurement was received, but at least one step was detected in the time interval. This could also include, for example, the target 301 remaining in a current state or selecting an extrapolated SH state when no wireless signal measurement was received, and no step was detected in the time interval.

At step 1405, the electronic device determines a location of an object using the tracking filter state machine based on the selected state. This could include, for example, the target 301 using the EKF−RW+SH state machine 600 to generate the location output 420, which indicates the location of the target 301.

Although FIG. 14 illustrates one example of a method 1400 for indoor localization of an object using a state machine, various changes may be made to FIG. 14. For example, while shown as a series of steps, various steps in FIG. 14 could overlap, occur in parallel, occur in a different order, or occur any number of times.

Although the present disclosure has been described with an exemplary embodiment, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A method comprising:
determining, for each time interval in a series of time intervals:
whether at least one wireless signal measurement was received in the time interval, each wireless signal measurement associated with a pair of anchors; and
whether at least one step was detected in the time interval;
selecting a state of a tracking filter state machine based on whether the at least one wireless signal measurement was received in the time interval and whether the at least one step was detected in the time interval; and
determining a location of an object using the tracking filter state machine based on the selected state.

2. The method of claim 1, wherein the at least one wireless signal measurement comprises ultra-wide band downlink time difference of arrival (UWB DL-TDoA) measurements.

3. The method of claim 1, wherein selecting the state of the tracking filter state machine comprises:
selecting a first state when the at least one wireless signal measurement was received, but no step was detected in the time interval;
selecting a second state when the at least one wireless signal measurement was received and the at least one step was detected in the time interval; and
selecting a third state when no wireless signal measurement was received, but the at least one step was detected in the time interval.

4. The method of claim 3, wherein:
the first state is an extended Kalman filter—random walk (EKF-RW) state;
the second state is an extended Kalman filter—step-and-heading (EKF-SH) state; and
the third state is a step-and-heading (SH) state.

5. The method of claim 3, wherein selecting the state of the tracking filter state machine further comprises:
when no wireless signal measurement was received and no step was detected in the time interval, performing one of:
remaining in a current state; or
selecting a fourth state comprising an extrapolated step-and-heading state.

6. The method of claim 3, wherein determining the location of the object using the tracking filter state machine based on the selected state comprises:
when either the first state or the second state is selected:
predicting a next location of the object for all pairs of anchors for which the at least one wireless signal measurement was received;
estimating distance differences, for all pairs of anchors for which the at least one wireless signal measurements was received, at the predicted next location;
comparing the estimated distance differences against measured distance differences; and
removing measured distance differences from consideration based on a result of the comparison.

7. The method of claim 1, wherein the at least one step was detected using one or more measurements from one or more motion sensors associated with the object.

8. A device comprising:
a transceiver; and
a processor operably connected to the transceiver, the processor configured to:
determine, for each time interval in a series of time intervals:
whether at least one wireless signal measurement was received in the time interval, each wireless signal measurement associated with a pair of anchors; and
whether at least one step was detected in the time interval;
select a state of a tracking filter state machine based on whether the at least one wireless signal measurement was received in the time interval and whether the at least one step was detected in the time interval; and
determine a location of an object using the tracking filter state machine based on the selected state.

9. The device of claim 8, wherein the at least one wireless signal measurement comprises ultra-wide band downlink time difference of arrival (UWB DL-TDoA) measurements.

10. The device of claim 8, wherein to select the state of the tracking filter state machine, the processor is configured to:
select a first state when the at least one wireless signal measurement was received, but no step was detected in the time interval;
select a second state when the at least one wireless signal measurement was received and the at least one step was detected in the time interval; and
select a third state when no wireless signal measurement was received, but the at least one step was detected in the time interval.

11. The device of claim 10, wherein:
the first state is an extended Kalman filter—random walk (EKF-RW) state;
the second state is an extended Kalman filter—step-and-heading (EKF-SH) state; and
the third state is a step-and-heading (SH) state.

12. The device of claim 10, wherein to select the state of the tracking filter state machine, the processor is further configured to:
when no wireless signal measurement was received and no step was detected in the time interval, perform one of:
remain in a current state; or
select a fourth state comprising an extrapolated step-and-heading state.

13. The device of claim 10, wherein to determine the location of the object using the tracking filter state machine based on the selected state, the processor is configured to:
when either the first state or the second state is selected:
predict a next location of the object for all pairs of anchors for which the at least one wireless signal measurement was received;
estimate distance differences, for all pairs of anchors for which the at least one wireless signal measurements was received, at the predicted next location;
compare the estimated distance differences against measured distance differences; and
remove measured distance differences from consideration based on a result of the comparison.

14. The device of claim 8, wherein the at least one step was detected using one or more measurements from one or more motion sensors associated with the object.

15. A non-transitory computer readable medium comprising program code that, when executed by a processor of a device, causes the device to:
determine, for each time interval in a series of time intervals:
whether at least one wireless signal measurement was received in the time interval, each wireless signal measurement associated with a pair of anchors; and
whether at least one step was detected in the time interval;
select a state of a tracking filter state machine based on whether the at least one wireless signal measurement was received in the time interval and whether the at least one step was detected in the time interval; and
determine a location of an object using the tracking filter state machine based on the selected state.

16. The non-transitory computer readable medium of claim 15, wherein the at least one wireless signal measurement comprises ultra-wide band downlink time difference of arrival (UWB DL-TDoA) measurements.

17. The non-transitory computer readable medium of claim 15, wherein the program code to select the state of the tracking filter state machine comprises program code to:
select a first state when the at least one wireless signal measurement was received, but no step was detected in the time interval;
select a second state when the at least one wireless signal measurement was received and the at least one step was detected in the time interval; and
select a third state when no wireless signal measurement was received, but the at least one step was detected in the time interval.

18. The non-transitory computer readable medium of claim 17, wherein:
the first state is an extended Kalman filter—random walk (EKF-RW) state;
the second state is an extended Kalman filter—step-and-heading (EKF-SH) state; and
the third state is a step-and-heading (SH) state.

19. The non-transitory computer readable medium of claim 17, wherein the program code to select the state of the tracking filter state machine further comprises program code to:
when no wireless signal measurement was received and no step was detected in the time interval, perform one of:
remain in a current state; or
select a fourth state comprising an extrapolated step-and-heading state.

20. The non-transitory computer readable medium of claim 17, wherein the program code to determine the location of the object using the tracking filter state machine based on the selected state comprises program code to:
when either the first state or the second state is selected:
predict a next location of the object for all pairs of anchors for which the at least one wireless signal measurement was received;
estimate distance differences, for all pairs of anchors for which the at least one wireless signal measurements was received, at the predicted next location;
compare the estimated distance differences against measured distance differences; and
remove measured distance differences from consideration based on a result of the comparison.
